(19) United States
(12) Patent Application Publication
(10) Pub. No.: US 2018/0174246 A1
(43) Pub. Date: Jun. 21, 2018

(54) SYSTEM AND METHOD FOR MONITORING FLEET PERFORMANCE

(71) Applicant: Caterpillar Inc., Peoria, IL (US)

(72) Inventors: Antonio VARELA, Mt Zion, IL (US); Maheshwar RAMOJU, Peoria, IL (US)

(73) Assignee: Caterpillar Inc., Peoria, IL (US)

(21) Appl. No.: 15/386,882

(22) Filed: Dec. 21, 2016

(51) Int. Cl. G06Q 50/02; G06Q 10/06

(52) U.S. Cl. CPC G06Q 50/02; G06Q 10/06393

(57) ABSTRACT

Systems and methods for monitoring fleet performance are provided. An exemplary system has an information collection portal to collect data relating to fleet performance from a plurality of work sites, each work site being associated with at least one fleet performing work at that work site. The system also has at least one processor configured to receive the data from the information collection portal and determine at least one fleet performance metric for each fleet. The processor is also configured to compare, for each fleet, the determined at least one fleet performance metric with a site goal to determine whether the site goal is met. The system also has an interface configured to display, in a tabular form, information of the fleets, the at least one performance metric for each of the fleets, and a performance indicator indicating whether the respective site goal is met for each of the fleets.

### TECHNICAL FIELD

This disclosure relates generally to mining equipment performance management, and more particularly, to systems and methods for monitoring performance of multiple fleets of equipment.

### BACKGROUND

In mining operations, fleet performance data such as physical availability (PA) are important measures for evaluating the performance of mining equipment, and they are valuable to both the equipment manufactures and mining customers. For example, mining customers often track the fleet performance data to access the total cost of ownership (TCO). In another example, equipment manufacturers who achieve high physical availabilities for their fleets are often rewarded with repeat business and in increased percentage of industry sales (PINS). Therefore, it is important to obtain, record, and track such fleet performance data effectively and efficiently, and to make the fleet performance data available to and easy to access by interested parties.

Traditional fleet performance monitoring systems relay fleet performance information through individual emails, regional or local dashboards, and isolated small databases. In order to disseminate fleet performance data such as physical availability to product support teams, design engineers, managers, and other decision makers, a series of complex and time-consuming data gathering tasks have to be carried out. Usually, this data gathering and processing cycle averages two months or more, which results in limited, outdated, and ambiguous fleet performance data. In addition, the fleet performance data are usually only made available to a small number of individuals, leaving a large group of people who would have benefited from the data uninformed.

International Application Publication No. WO 2016/115499 A1 to Steketee et al. describes a monitoring and maintenance system to track operation events of heavy-duty vehicles by installing monitor devices on the vehicles. The monitor devices can collect sensor data over time to be compared with imperial and theoretical data to predict or prevent downtimes. While the system disclosed in WO 2016/115499 A1 tracks certain aspects of the working condition of the heave-duty vehicles, that system lacks the ability to collect and analyze important fleet performance metrics such as physical availability information across multiple fleets.

The present disclosure is directed to overcoming or mitigating one or more of these problems set forth.

### SUMMARY OF THE INVENTION

In one aspect, the present disclosure is directed to a fleet performance monitoring system. The system includes an information collection portal configured to collect data relating to fleet performance from a plurality of work sites, each work site being associated with at least one fleet performing work at that work site. The system also includes at least one processor configured to receive the data from the information collection portal and determine, based on the data, at least one fleet performance metric for each fleet. The at least one processor may also be configured to compare, for each fleet, the determined at least one fleet performance metric with a site goal to determine whether the site goal is met. The system also includes an interface configured to display, in a tabular form, information of the fleets, the determined at least one performance metric for each of the fleets, and a performance indicator indicating whether the respective site goal is met for each of the fleets.

In another aspect, the present disclosure is directed to a method for monitoring fleet performance. The method includes receiving data relating to fleet performance from a plurality of work sites, each work site being associated with at least one fleet performing work at that work site. The method also includes determining, based on the data, at least one fleet performance metric for each fleet. The method also includes comparing, for each fleet, the determined at least one fleet performance metric with a site goal to determine whether the site goal is met. The method also includes displaying, in a tabular form, information of the fleets, the determined at least one performance metric for each of the fleets, and a performance indicator indicating whether the respective site goal is met for each of the fleets.

### BRIEF DESCRIPTION OF THE DRAWINGS

FIG. 1 is a diagram of an exemplary embodiment of a fleet performance monitoring system;

FIG. 2 is a block diagram of an exemplary embodiment of a server;

FIG. 3 is a block diagram of an exemplary embodiment of a terminal device for displaying an interface showing fleet performance data;

FIG. 4 illustrates an exemplary interface showing fleet performance data of multiple fleets;

FIG. 5 illustrates an exemplary interface showing fleet performance data of a single fleet over a period of time; and

FIG. 6 is a flow chart illustrating an exemplary method of monitoring fleet performance.

### DETAILED DESCRIPTION

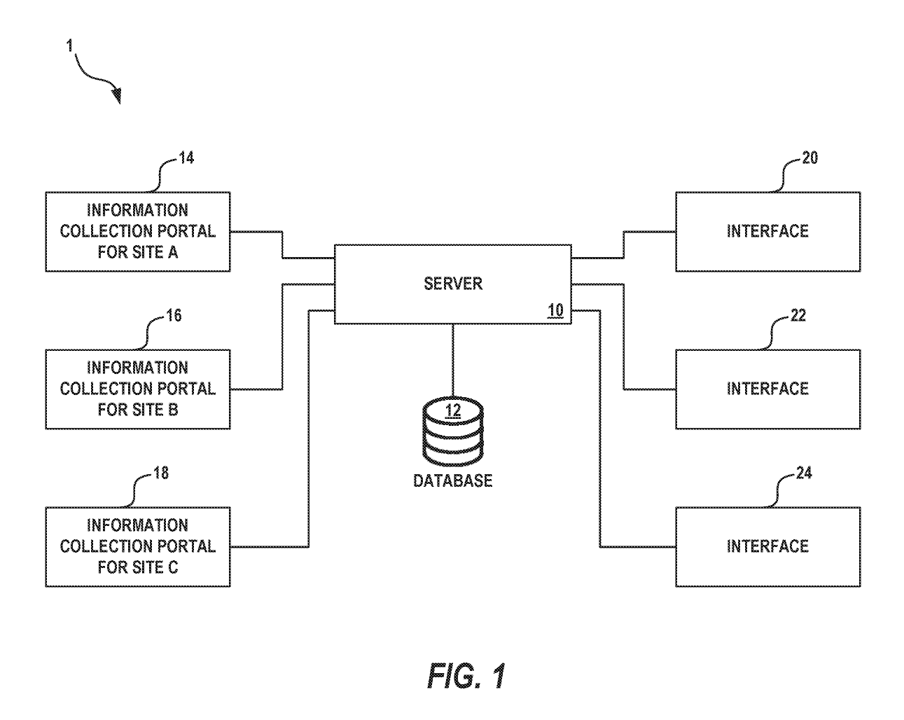

FIG. 1 is a diagram of an exemplary embodiment of a fleet performance monitoring system, according to one aspect of the disclosure. In FIG. 1, fleet performance monitoring system 1 includes a server 10 and a database 12 in communication with server 10. In some embodiments, server 10 may include one or more computers running a server operating system, such as Microsoft Windows system, Linux system, Unix system, Max OSX system, or the like. Server 10 may include software program(s) for performing various tasks relating to fleet performance monitoring, as will be described in more detail below. In some embodiments, server 10 may include a Python script to implement all or part of the fleet performance monitoring functionalities. It would be apparent to a person skilled in the art to implement the functionalities using other computer languages, such as Java, Javascript, Perl, C/C++, or the like. Database 12 may act as a data repository and include one or more suitable databases for storing data and providing access to the stored data. Database 12 may include a MySQL database, an Oracle database, a Microsoft SQL database, an XML database, or the like.

System 1 may include a plurality of information collection portals such as 14, 16, and 18. Portals 14, 16, and 18 may be implemented as a website, a mobile app, a special-designed terminal device, a data communication link to machine/equipment, or any other suitable forms to collect data relating to fleet performance from a plurality of work sites. For example, a work site may be located remotely from server 10 and/or database 12, and one or more fleets of mining equipment may perform work at the work site. A site manager or any person responsible for collecting and reporting fleet performance data may periodically input the fleet performance data through the portal. For example, the data may be input every day, every week, every bi-week, every month, every quarter, etc. In some embodiments, the data may be input to the portal at the work site. In other embodiments, the data may be input to the portal anywhere in the world, as long as the data relate to the performance of the fleet working at the work site. In some embodiments, some fleet performance data may be collected directly from an equipment through a communication link connected to the equipment.

System 1 may also include an interface for displaying fleet performance information, such as interfaces 20, 22, and 24 shown in FIG. 1. The interface may be implemented as a webpage accessible through a connected computer, a mobile app installed on a mobile device such as a phone, a tablet, or the like, or any other suitable means for providing access to the fleet performance information. The interface may be available to a plurality of interested parties, such as site performance managers, regional account managers, design engineers, resource industries executive teams, etc.

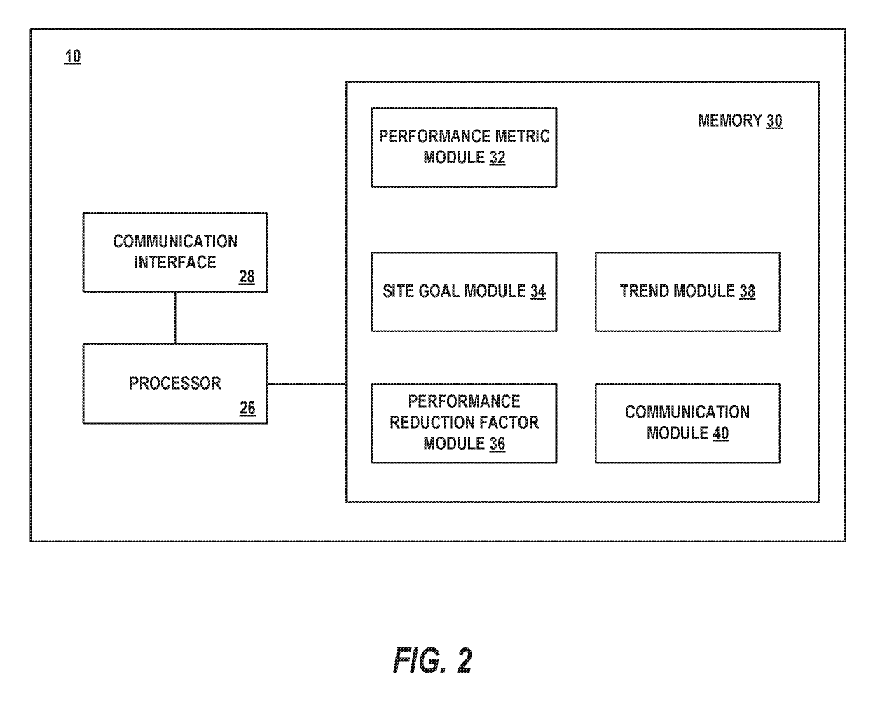

FIG. 2 is a block diagram of an exemplary embodiment of server 10. Referring to FIG. 2, server 10 may include a processor 26. While FIG. 2 shows a single block representing the processor, in some embodiments multiple processors may be used or processor 26 may be provided in a distributed manner as a plurality of distinct but interoperating units. Server 10 may also include a communication interface 28 in communication with processor 26. Communication interface 28 may include network adaptor(s) equipped with appropriate protocol(s) to establish data communication link(s) between server 10 and information collection portals 14, 16, and 18; between server 10 and database 12; and/or between server 10 and interfaces 20, 22, and 24. For example, fleet performance data collected by portal 14/16/18 may be received by processor 26 through communication interface 28. In another example, fleet performance information generated by processor 26 may be transferred to interface 20/22/24 for displaying through communication interface 28.

Server 10 may also include a memory 30 in communication with processor 26. Memory 30 may include a random access memory (RAM), a read-only memory (ROM), a flash memory, or the like. Memory 30 may store computer executable codes or instructions including algorithm(s) for processing the fleet performance data received from information collection portal(s) 14/16/18. The computer executable codes or instructions may be organized as software modules according to their functionalities. As shown in FIG. 2, memory 30 may include a performance metric module 32, a site goal module 34, a performance reduction factor module 36, a trend module 38, and a communication module 40.

Processor 26 may receive data from one or more information collection portals, such as portals 14, 16, and 18, process the data using one or more software modules, and store the received data and/or information generated from the data processing in database 12. In some embodiments, data storage in database 12 may be performed on an hourly basis.

Data received from information collection portal(s) may include a physical availability (PA) of a fleet for a specified time period, such as a month. PA is an indicator of reliability and availability, and is quantified based on the percentage of time a fleet equipment is available for use and the percentage of time the fleet equipment suffers downtime. Specifically, PA can be defined as follows:

PA=(operating hours+standby hours)/(operating hours+standby hours+downtime hours).

The downtime hours may include scheduled and unscheduled downtime hours. The scheduled downtime refers to the downtime due to, for example, scheduled maintenance. The unscheduled downtime refers to the downtime caused by, for example, a mechanical failure, flat tire, etc. The data for calculating PA may be obtained from the work site where the fleet performs work, from the dealer or the customer of the work site, etc. In some embodiments, a person, such as a site manager, may collect the data and calculate the PA of a fleet, and input the PA via the information collection portal (e.g., portal 14).

In some embodiments, information collection portal(s) 14/16/18 may collect performance data directly from the machine or equipment. For example, utilization rate is an uptime metric defined by: utilization rate=(operating hours)/(calendar hours). The operating hour data may be extracted from the machine or equipment, whereas the calendar hour information may be easily determined. In some embodiments, information collection portal (e.g., portal 16) may collect the operating hour data directly from the equipment in a fleet. Processor 26 may receive the collected operating hour data. In some embodiments, the utilization rate may be pre-calculated by the information collection portal based on the collected operating hour data and the calendar hour information.

In some embodiments, information collection portal(s) 14/16/18 may collect other fleet performance data such as a mean time between shutdown (MTBS), a mean time between failure (MTBF), and a mean time to repair (MTTR). These performance metrics are defined as follows:

MTBS=(operating hours+production delay hours)/(number of shutdowns);

MTBF=(operating hours+production delay hours)/(number of shutdowns, where the shutdowns resulted from mechanical failure); and

MTTR=(total downtime hours)/(number of shutdowns).

In some embodiments, the MTBS/MTBF/MTTR data may be input by a person, such as a site manager, after collecting and calculating the relevant numbers. In some embodiments, at least part of the data for calculating these performance metrics may be collected directly from the machines or equipment of a fleet (e.g., operating hours and number of shutdowns).

Data collected by the information collection portal(s) 14/16/18 may also include context information such as site location, site manager, dealer, customer, fleet information, mineral, etc. Data collected by the information collection portal(s) may also include a site goal, such as a monthly PA goal set for a particular work site.

Performance metric module 32 may determine at least one fleet performance metric for each fleet based on data received from information collection portal(s) 14/16/18. For example, performance metric module 32 may determine a time-averaged PA for a fleet based on PA data over a period of time. For example, performance metric module 32 may access PA data (e.g., by accessing data stored in database 12) received from the information collection portal(s) for the previous year and determine an average PA for the previous year. Similarly, performance metric module 32 may determine an average PA for the current year-to-date and/or for a predetermined number of part months, such as a rolling 6-month period (R6).

Site goal module 34 may compare the average PA with the site goal received from the information collection portal(s) to determine whether the site goal is met. In some embodiments, if the average PA is equal to or above the site goal, then site goal module 34 may determine that the site goal is met. If the average PA is below the site goal by no more than a predetermined percentage, such as 5 percent, then site goal module 34 may determine that, while the site goal is not met, it is close. If the average PA is below the site goal by more than, for example, 5 percent, then site goal module 34 may determine that the site goal is not met.

In some embodiments, performance metric module 32 may also determine one or more of the MTBS, MTBF, and/or MTTR. For example, when the data received from the information collection portal include raw data such as operating hours, shutdown numbers, etc., performance metric module 32 may calculate the one or more performance metrics (e.g., MTBS, MTBF, and/or MTTR) based on the raw data.

Performance reduction factor module 36 may determine one or more factors that reduce fleet performance of at least one fleet. For example, performance reduction factor module 36 may analyze the data received from the information collection portal(s) to identify reason(s) or factor(s) causing the unavailability, thereby reducing the fleet performance. The reasons/factors may be machine related, such as scheduled maintenance, mechanical failure, tire/rim failure, etc. In some embodiments, performance reduction factor module 36 may analyze the data for a specified time period (e.g., the time period may be predetermined or dynamically set by a user) and identify one or more common factors causing the unavailability during that time period. Performance reduction factor module 36 may then determine the respective contributions of each identified factor. For example, during a 6-month period, there may be in total 100 downtime hours (equipment unavailable hours). Of the 100 downtime hours, 45 hours may be due to scheduled maintenance, 25 hours may be due to engine failure, 15 hours may be due to transmission failure, 10 hours may be due to flat tire, etc. Performance reduction factor module 36 may determine the contribution of each identified factor and sort the factors according to their respective contributions. For example, performance reduction factor module 36 may determine the top 5 factors that caused performance reduction in the past 6 months, or top 3 unscheduled factors, or top factors with their contributions higher than a threshold, or the like.

Trend module 38 may determine a trend of at least one performance metric of a fleet over a period of time, e.g., a year, half a year, or any number of months. For example, based on the data received from information collection portal(s), trend module 38 may determine whether, for instance, the PA of a fleet is in general in an upward or downward trend. The trend may be determined through many ways. For example, if the most recent one or a few PA number is larger than the average PA over the entire period of time under consideration, then trend module 38 may determine that the trend is an upward trend. Otherwise, the trend may be determined to be a downward trend. In another example, a curve fitting approach may be used, in which a curve is calculated by trend module 38 to fit the PA numbers over a time period, and the upward/downward polarity may be determined based on the sign (positive or negative) of the first order derivative of the curve. Other methods for determining a trend based on a plurality of data points may also be used.

Communication module 40 may facilitate data communication among components of system 1. In some embodiments, the data communication function specific to fleet performance monitoring may be implemented by communication module 40, which may utilize the standard data communication protocol(s) provided by communication interface 28. For example, low level data transfer between database 12 and server 10, such as database handling, storing/fetching of fleet performance data, or the like, may be implemented by communication module 40 such that database operation details are transparent to higher level function modules such as performance metric module 32, site goal module 34, etc.

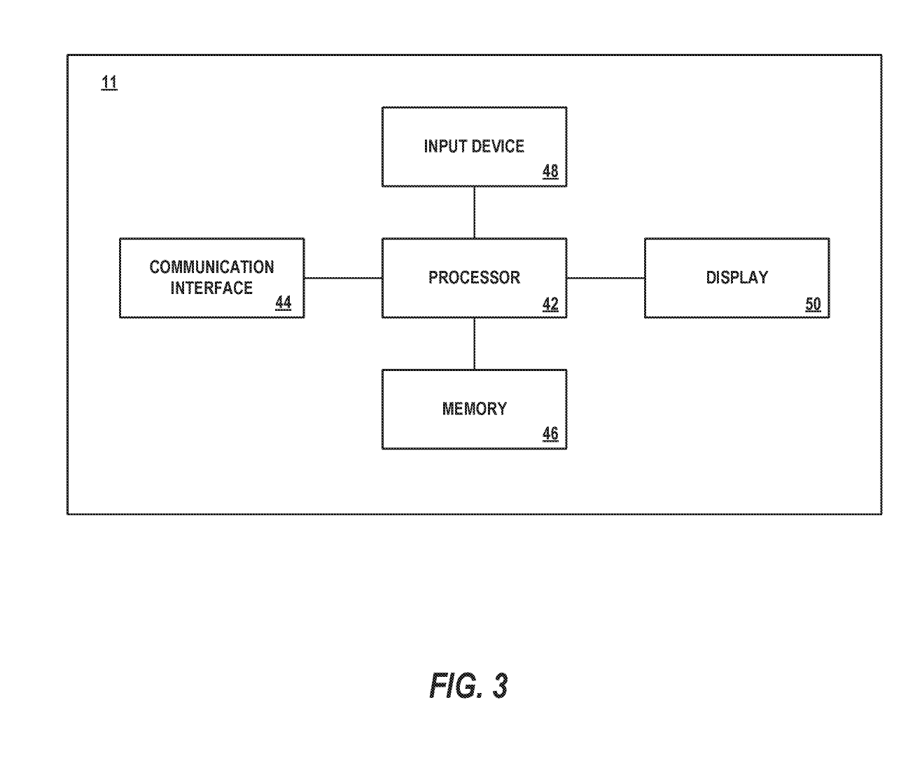

FIG. 3 is a block diagram of an exemplary embodiment of a terminal device 11 for display interface 20/22/24. Terminal device 11 may include a computer, such as a desktop computer, a laptop computer, or the like. Terminal device 11 may also include a mobile device, such as a phone, a tablet, or the like. Terminal device 11 may also include specially design devices such as handheld devices, vehicle mounted devices, etc. In general, terminal device 11 includes any device capable of display an interface.

As shown in FIG. 3, terminal device 11 may include a processor 42 (e.g., a CPU, a microprocessor, etc.), a memory 46 (e.g., a RAM, a ROM, a flash memory, etc.), a communication interface 44 (e.g., a network adaptor, a telecommunication module, a Bluetooth module, etc.), an input device 48 (e.g., a keyboard, a mouse, a touch screen, etc.), and a display 50 (e.g., a monitor, a LCD, etc.). Communication interface 44 of terminal device 11 may communicate with communication interface 28 of server 10 to receive fleet performance data for displaying on display 50.

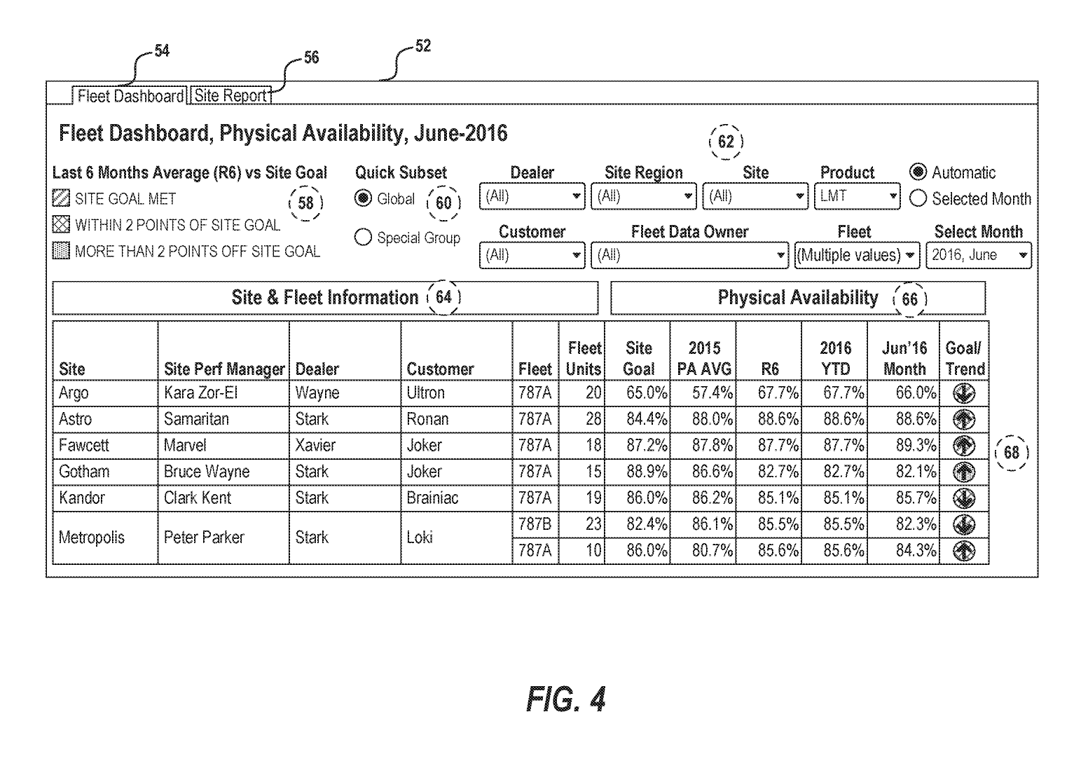

FIG. 4 shows an exemplary interface 52 that may be displayed on display 50. As shown in FIG. 4, interface 52 may include one or more tabs, such as tab 54 (Fleet Dashboard) and tab 56 (Site Report) showing information organized in different ways. Tab 54 may show information across multiple fleets in a tabular form. For example, site and fleet information of multiple fleets are shown in the area marked by reference number 64 in tabular form (because the interface includes many information, a reference number in a dashed line circle is used to indicate a specific area of the interface). The site information may include the site location, site manager, dealer, and customer. The fleet information may include the product (equipment) and model (e.g., 787A), as well as the number of units in a fleet. As discussed above, the site and fleet information may be received from the information collection portals and/or from stored data in database 12. Physical availabilities of the multiple fleets are shown in area 66. PA information may include the site goal for each site, previous year average, rolling 6-month average, current year-to-date average, and current month PA numbers. The site goal information may be received from the information collection portals and/or provided by site goal module 34. The PA information may be received from the information collection portals and/or provided by performance metric module 32. PA information may also include a performance indicator indicating whether the site goal is met, based on information provided by site goal module 34. For example, area 68 includes a circle having a specified shading pattern for each fleet indicating whether the site goal is met by that fleet. Explanation of the shading patterns is included in area 58. In addition, area 68 may also include a trending indicator (e.g., an arrow pointing upward or downward) indicating the trend of the PA number for each fleet based on the trend information provided by trend module 38.

Tab 54 may also include a plurality of selection tools for selecting a particular fleet or a group of fleets. For example, area 60 includes a quick selection tool for selecting either global fleets (e.g., all available fleet) or a special group of fleets (e.g., a group that is specially designated). Area 62 may include a plurality of dropdown lists for selecting fleets associated with a specific dealer, site region, site, product, customer, fleet data owner, and fleet. Depending on the selections, the table shown in areas 64 and 66 may change their content. Area 62 may also include selection tools for selecting a specific time period. When Automatic is selected, PA information shown in area 66 may be displayed (e.g., PA averages and current month PA number). When Selected Month is chosen, a user may choose a specific month to view the PA numbers.

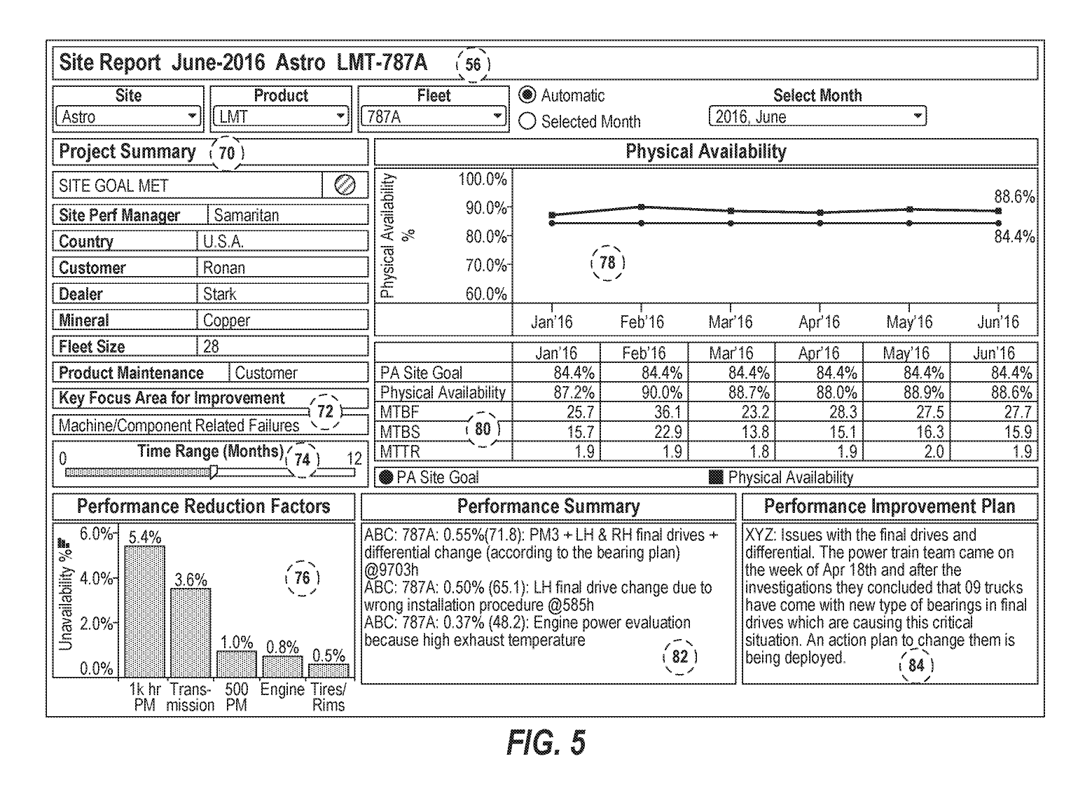

FIG. 5 shows an exemplary interface when Site Report tab (tab 56) is selected. Tab 56 shows fleet performance information of a single fleet. As shown in FIG. 5, tab 56 may include a Project Summary area 70 showing site information and whether the site goal is met. Area 72 includes a Key Focus Area for Improvement based on, for example, information provided by performance reduction factor module 36. Area 74 includes a time bar for changing the time span of the performance data displayed in tab 56. Area 76 includes the top 5 performance reduction factors that cause unavailability, based on information provided by performance reduction factor module 36. The factors are display in the order of their respective contributions to the reduction of fleet performance (e.g., percentage of unavailability). Area 78 includes a trending chart showing the trend of PA in graphic form together with site goals. Area 80 shows various fleet performance metrics (e.g., provided by performance metric module 32) over the selected time span (selected in area 74). Area 82 includes performance summary logging the details of each action associated with downtime hours or unavailability. Area 84 includes proposed Performance Improvement Plan aiming to improve the fleet performance.

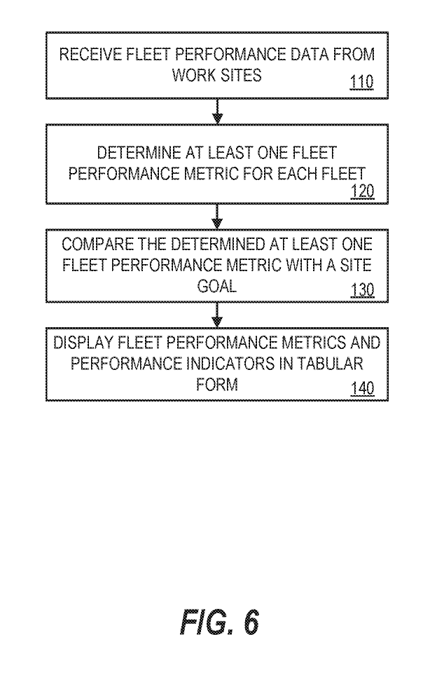

FIG. 6 is a flowchart depicting a method for monitoring fleet performance. In step 110, processor 26 receives fleet performance data from a plurality of work sites through information collection portals 12/14/16. The fleet performance data may include PA numbers, equipment operating hours, downtime numbers, etc. that may be input by a person or extracted from machine. In step 120, processor 26 may determine at least one fleet performance metric for each fleet. For example, performance metric module 32 may determine averaged PA numbers over different time spans, MTBS, MTBF, MTTR, etc. In step 130, processor 26 may compare the determined performance metric with a site goal. For example, site goal module 34 may compare an averaged PA number with a site goal PA number to determine whether the site goal is met. In step 140, processor 26 may control interface 20/22/24 to display, in a tabular form, information of the fleets (e.g., area 64), the determined performance metric(s) (e.g., area 66), and a performance indicator (e.g., area 68) indicating whether the respective site goal is met for each fleet.

### INDUSTRIAL APPLICABILITY

The present disclosure provides an advantageous system and method for monitoring fleet performance. The system may be used to monitor fleet performance for a wide range of mining equipment, such as mining trucks, electric rope shovels, hydraulic mining shovels, wheel loaders, etc. The streamlined data collection, calculation, and presentation approach greatly shorten the time required to document and update the fleet performance metrics, making the performance information more accurate, up-to-date, and useful. In addition, the integrated interface includes in-depth analysis of the performance metrics, and is available to a much larger audience, ranging from marketing teams, site/regional managers, to design teams and high-level executives. As a result, the decision making process benefits from the previously unavailable fleet performance information.

It will be apparent to those skilled in the art that various modifications and variations can be made to the disclosed embodiments. Other embodiments will be apparent to those skilled in the art from consideration of the specification and practice of the disclosed embodiments. It is intended that the specification and examples be considered as exemplary only, with a true scope being indicated by the following claims and their equivalents.

What is claimed is:

1. A fleet performance monitoring system, comprising:
an information collection portal configured to collect data relating to fleet performance from a plurality of work sites, each work site being associated with at least one fleet performing work at that work site;
at least one processor configured to:
receive the data from the information collection portal;
determine, based on the data, at least one fleet performance metric for each fleet; and
compare, for each fleet, the determined at least one fleet performance metric with a site goal to determine whether the site goal is met; and
an interface configured to display, in a tabular form, information of the fleets, the determined at least one performance metric for each of the fleets, and a performance indicator indicating whether the respective site goal is met for each of the fleets.

2. The fleet performance monitoring system of claim 1, wherein the at least one fleet comprises a plurality of mining equipment.

3. The fleet performance monitoring system of claim 1, wherein the at least one fleet performance metric includes a time-averaged physical availability of the corresponding fleet.

4. The fleet performance monitoring system of claim 3, wherein the time-averaged physical availability includes at least one of a previous year average, a current year-to-date average, or a predetermined number of past months average.

5. The fleet performance monitoring system of claim 1, wherein the at least one fleet performance metric includes at least one of a mean time between shutdown (MTBS), a mean time between failure (MTBF), or a mean time to repair (MTTR).

6. The fleet performance monitoring system of claim 1, wherein the controller is further configured to:
determine, based on the data received from the information collection portal, a plurality of factors that reduce fleet performance of at least one fleet, and
control the interface to display the plurality of factors in an order of their respective contributions to the reduction of the fleet performance.

7. The fleet performance monitoring system of claim 6, wherein the plurality of factors are machine related.

8. The fleet performance monitoring system of claim 1, wherein the controller is further configured to determine, for at least one fleet, a trend of the determined at least one performance metric over a predetermined time period.

9. The fleet performance monitoring system of claim 8, wherein the controller is further configured to control the interface to display a trending chart showing the determined trend.

10. The fleet performance monitoring system of claim 8, wherein the controller is further configured to control the interface to display a trending indicator indicating the determined trend together with the performance indicator.

11. The fleet performance monitoring system of claim 1, wherein controller is further configured to store the received data from the information collection portal in a repository on an hourly basis.

12. A method for monitoring fleet performance, comprising:
receiving data relating to fleet performance from a plurality of work sites, each work site being associated with at least one fleet performing work at that work site;
determining, based on the data, at least one fleet performance metric for each fleet;
comparing, for each fleet, the determined at least one fleet performance metric with a site goal to determine whether the site goal is met; and
displaying, in a tabular form, information of the fleets, the determined at least one performance metric for each of the fleets, and a performance indicator indicating whether the respective site goal is met for each of the fleets.

13. The method of claim 12, wherein the at least one fleet performance metric includes a time-averaged physical availability of the corresponding fleet.

14. The method of claim 13, wherein the time-averaged physical availability includes at least one of a previous year average, a current year-to-date average, or a predetermined number of past months average.

15. The method of claim 12, wherein the at least one fleet performance metric includes at least one of a mean time between shutdown (MTBS), a mean time between failure (MTBF), or a mean time to repair (MTTR).

16. The method of claim 12, further comprising:
determining, based on the received data, a plurality of factors that reduce fleet performance of at least one fleet; and
displaying the plurality of factors in an order of their respective contributions to the reduction of the fleet performance.

17. The method of claim 16, wherein the plurality of factors are machine related.

18. The method of claim 12, further comprising:
determining, for at least one fleet, a trend of the determined at least one performance metric over a predetermined time period.

19. The method of claim 18, further comprising:
display a trending chart showing the determined trend.

20. The method of claim 18, further comprising:
displaying a trending indicator indicating the determined trend together with the performance indicator.
